(19) United States
(12) Patent Application Publication
(10) Pub. No.: US 2015/0249295 A1
(43) Pub. Date: Sep. 3, 2015

(54) DISCONNECT WITH ENHANCED ELECTRICAL CONTACT

(71) Applicant: HEAVY POWER CO. LTD., Taipei Hsien (TW)

(72) Inventor: Peter TSENG, Taipei Hsien (TW)

(73) Assignee: HEAVY POWER CO. LTD., Taipei Hsien (TW)

(21) Appl. No.: 14/195,069

(22) Filed: Mar. 3, 2014

(51) Int. Cl. H01R 4/48; H01R 13/627; H01R 27/02; H01R 11/05

(52) U.S. Cl. CPC H01R 4/4854; H01R 11/05; H01R 13/6273; H01R 27/02

(57) ABSTRACT

A disconnect has a pair of male and female connector housings and a pair of male and female connectors. The male connector housing has a male connector engagement socket. The female connector housing has a female connector engagement socket for sleeve-engagement with the male connector engagement socket. The male connector is inside the male connector housing and has a male connector engagement end. The female connector is inside the female connector housing and has a female connector engagement end. The female connector engagement end has a contact finger and a pressure finger for mechanically gripping engagement with the male connector engagement end when sleeve-engaged and the male connector engagement end is inserted between the contact and pressure fingers. The tips of the contact finger and the pressure finger are forced apart from each other by the engagement insertion and are pressed onto inner sidewalls of the female connector engagement socket.

### BACKGROUND

1. Field of the Invention

The present invention relates in general to a push-in electrical connector for wires and, in particular, to a disconnect for repeatable connection of multiple wires of either single- or multi-thread. More particularly, the present invention relates to a disconnect that provides electrical connection using a male and female engagement with enhanced mechanical contact pressure.

2. Description of the Related Art

Push-in wire connectors are useful for connecting multiple wires electrically together in applications that include, for example, providing utility power grid for homes and offices, etc. When equipped with a repeatably engage and disengage connector design, such electrical disconnect is greatly useful in applications such as typically used in the ballast connection for fluorescent light fixture per the requirement of Section 410.73 of the National Electrical Code.

U.S. Pat. No. 7,887,353 to Bethurum et al. discloses an electrical disconnect with push-in connector design. This disconnect relies on a dimple formed on the male and female contacts to facilitate electrical contact between its separable connectors. However, this configuration does not provide sufficiently good electrical connection between its male and female contacts due to insufficient mechanical contact pressure to warrant good disconnect characteristics, namely, good current rating, which affects directly the disconnect's safety characteristics.

The disconnect according to Bethurum et al. has a pair of dimples formed on the male and female contacts. This pair of corresponding dimples are normally put to a natural relax condition as the housings of the disconnect are fully engaged. In other words, the dimples contribute their mechanical stress only in the process of disconnect installation. After this transient state, the dimples contributes nothing to the improvement of electrical contact characteristics of the disconnect.

### SUMMARY OF THE INVENTION

It is therefore an object of the present invention to provide a disconnect for electrically connecting wire pairs that has increased mechanical grip between contacting connectors for improved electrical conductivity.

It is another object of the present invention to provide a disconnect for electrically connecting wire pairs that has increased mechanical grip between contacting connectors for improved safety.

The present invention achieves the above and other objects by providing a disconnect (10) for electrically connecting wire pairs according to a preferred embodiment of the present invention. The disconnect has a pair of male and female connector housings as well as a pair of male and female connectors. The male connector housing (102) has a male connector engagement socket (103) and the female connector housing (202) has a female connector engagement socket (203) for sleeve-engagement with the male connector engagement socket (103). The male connector (120) is housed inside the male connector housing (102) and has a male connector engagement end (122). The female connector (220) is housed inside the female connector housing (202) and has a female connector engagement end (222). The female connector engagement end (222) has a contact finger (240) and a pressure finger (250) for mechanical gripping engagement with the male connector engagement end (122) when the male and female connector housings (102, 202) are sleeve-engaged and the male connector engagement end (122) is inserted between the contact and pressure fingers (240, 250). In the preferred embodiment of the disconnect of the present invention, contact finger tip (245) of the contact finger (240) and the pressure finger tip (255) of the pressure finger (250) are forced apart from each other by the engagement insertion and are pressed onto inner sidewalls of the female connector engagement socket (203) for increasing the mechanical grip.

The present invention further provides a disconnect wherein the internal space inside the female connector engagement socket (203) has a width that is larger than a distance between the contact finger tip (245) of the contact finger (240) and the pressure finger tip (255) of the pressure finger (250) when the male connector engagement end (122) is not inserted between the contact (240) and pressure finger (250).

The present invention further provides a disconnect wherein the width between finger tips (245, 255) of the two fingers (240, 250) of the female connector (220) is the widest portion of its body along an entire length-wise direction with or without the insertion of the male connector (120).

### BRIEF DESCRIPTION OF THE DRAWING

FIG. 1 is an exploded perspective view of the disconnect in accordance with a preferred embodiment of the present invention.

FIG. 2 is a perspective view of the disconnect of FIG. 1 when fully assembled for the electrical connection of a pair of electrical wires.

FIG. 3 is a cross-sectional view of a disconnect in accordance with a preferred embodiment of the present invention for which the male and female connectors are aligned but not yet electrically connected at full insertion.

FIG. 4 is a cross-sectional view of the disconnect of FIG. 3 for which the male and female connectors are fully and firmly mated.

FIG. 5 is a perspective view of the male connector for the disconnect.

FIG. 6 is a perspective view of the female connector for the disconnect.

FIG. 7 is another perspective view of the female connector for the disconnect.

FIG. 8 is the side view of the female connector for the disconnect.

FIG. 9 is a detailed cross-sectional view of the disconnect of FIG. 3 with male and female connectors fully mated showing how the female connector exerts improved contact pressure to the male connector.

FIG. 10 schematically illustrates the side view of the female connector before receiving the insertion of the mating male connector inside the engagement socket section of the female connector housing.

FIG. 11 schematically illustrates the side view of the female connector after receiving the insertion of the mating male connector inside the engagement socket section of the female connector housing.

FIG. 12 is a cross-sectional view illustrating the structure to securely house and hold the male connector inside its housing.

FIG. 13 is a cross-sectional view illustrating the structure to securely house and hold the female connector inside its housing.

### DETAILED DESCRIPTION OF THE PREFERRED EMBODIMENTS

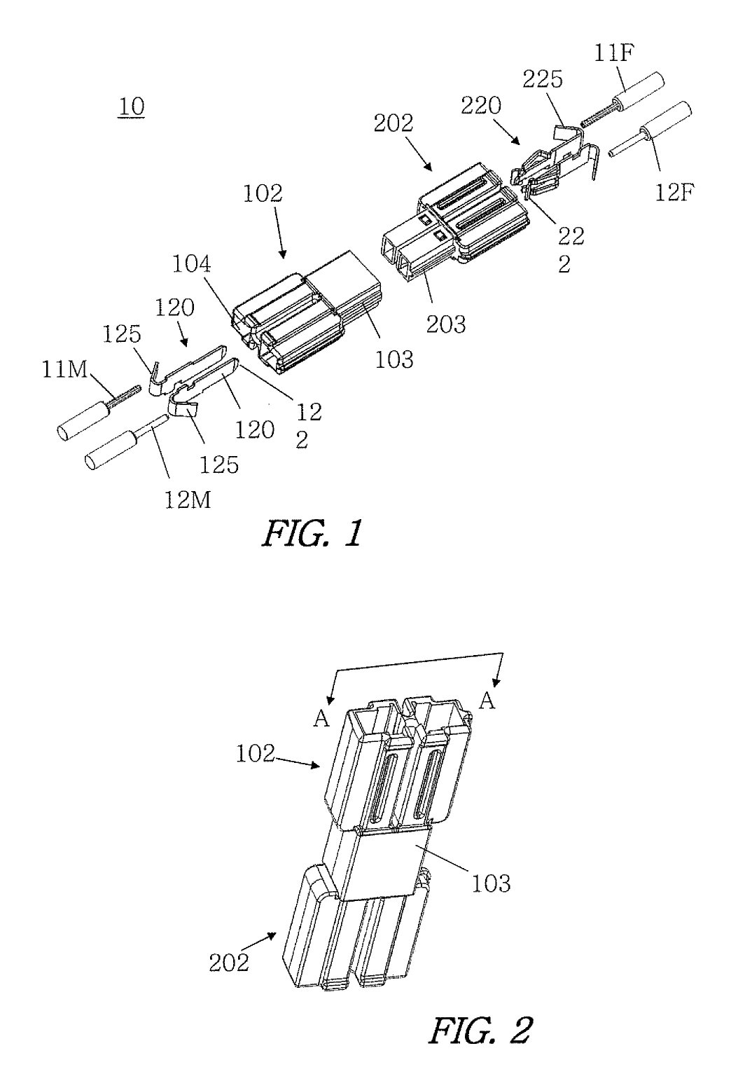

FIG. 1 is an exploded perspective view of a disconnect 10 in accordance with a preferred embodiment of the present invention. FIG. 2 is a perspective view of the disconnect of FIG. 1 when fully assembled for the electrical connection of a pair of electrical wires. The depicted embodiment of FIGS. 1 and 2 can be used to facilitate the electrical connection and disconnection of two wires, repeatedly when necessary, such as typically used in the ballast connection for fluorescent light fixture per the requirement of Section 410.73 of the National Electrical Code. Although two-wire connection and disconnection are exemplified herein in the preferred embodiments described below, however, as is comprehensible, the connection and disconnection of wire sets with more than two wires can be facilitated under the present invention using a varied disconnect.

A first segment of a first wire of a circuit, shown in FIG. 1 as the wire segment 11M, which is connected to the end of the male connector 120 of the disconnect 10, can be electrically connected to the opposite wire segment 11F, which is connected to the end of the female connector 220. When the disconnect 10 is assembled such as shown in FIG. 2 and the metallic male connector 120 is firmly mated with the metallic female connector 220, wire segments 11M and 11F, as a result, are electrically connected together to establish one electrical circuit.

Similarly, when assembled, a first segment of 12M of a second wire, connected to the male connector 120, can be electrically connected to its opposite wire segment 12F at the end of the female connector 220, forming a second wire circuit for the application. Note that when properly assembled, as is clearly illustrated in FIG. 2, the engagement socket 203 of the female connector housing 202 is inserted completely inside the engagement socket 103 of the male connector housing 102.

Connection of wires 11F and 12F with their respective female connectors 220 as well as wires 11M and 12M with respective male connectors 120, as illustrated in the exploded perspective view of FIG. 1, is via a conventional simple dislodge-proof blade engagement arrangement. As is shown in the illustration, both the male 120 and female connector 220 have a wire engagement blade angled at an acute angle relative to the direction of wire insertion when the wire is installed to the disconnect. For example, the male connector 120 for wire 12M has a wire engagement blade 125 that is pointing toward a tilted direction with respect to the insertion direction of wire 12M as it is connected to the disconnect 10 by insertion. Similarly, female connector 220 has wire engagement blade 225. Thus, when the male and female connectors 120 and 220 are properly installed inside their respective housings 102 and 202, such blades achieve a firm electrical connection between the wires 11M, 11F, 12M and 12F and the disconnect 10.

In order for the inventive disconnect 10, when assembled, to ensure a secure and reliable electrical connection between the wire pairs 11M and 11F and between 12M and 12F, there must be a secure and firm electrical contact between the male 120 and female connector 220 of disconnect 10. Meanwhile, it is necessary to also have a secure and firm mechanical engagement between the male connector housing 102 and the female connector housing 202. This secure and firm mechanical engagement of housings ensures the reliable electrical connection.

Equally necessary, the disengagement between male 120 and female connector 220 as well as between the male connector housing 102 and the female connector housing 202 must be easy and convenient. This is necessary for the disconnect 10 to easily facilitate its functionality of electrical disconnection between wire pairs 11M and 11F and between 12M and 12F, a feature as important as providing firm and secure electrical connection.

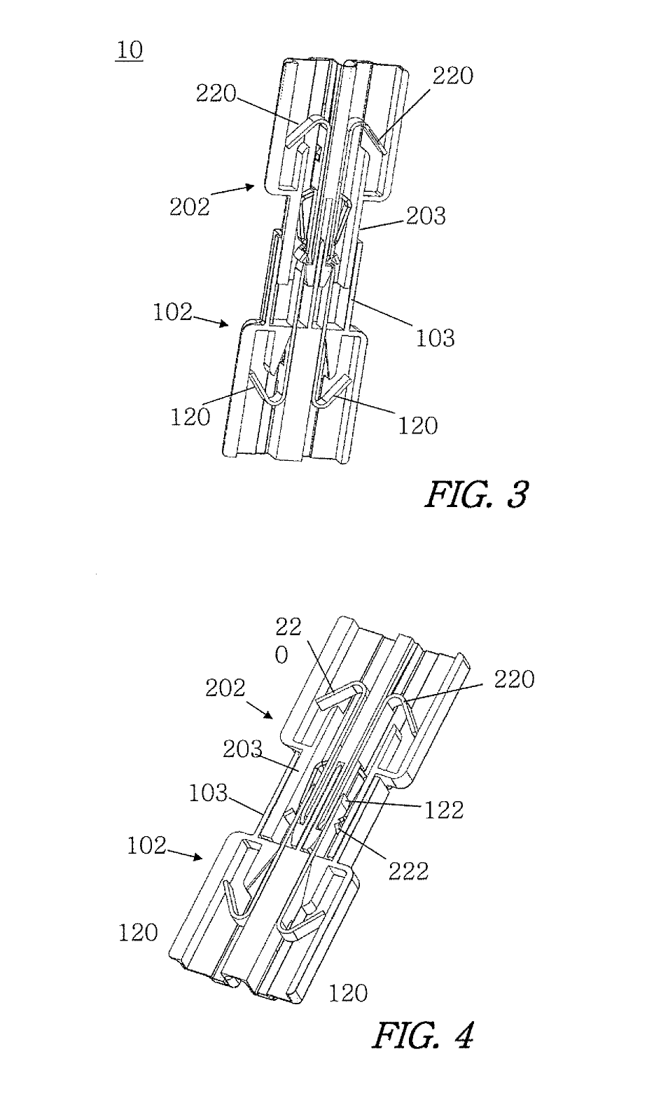

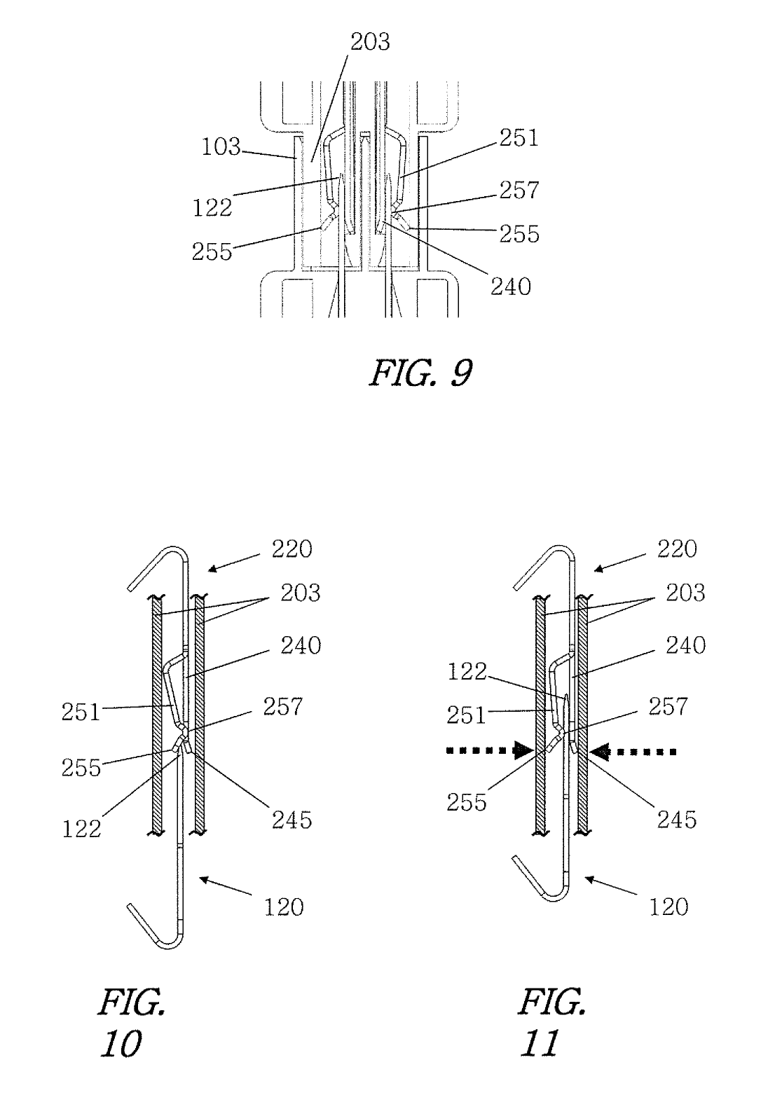

FIG. 3 is a cross-sectional view of a disconnect in accordance with a preferred embodiment of the present invention. Male 120 and female connector 220 of the illustrated disconnect 10 are aligned but not yet electrically connected at full insertion. FIG. 4 is a cross-sectional view of the disconnect of FIG. 3 for which the male and female connectors are fully and firmly mated. Note that the cross-sectional views of FIGS. 3 and 4, as well as FIGS. 9, 12 and 13 are taken along the central cutting plane indicated by the A-A line in FIG. 2.

When the inventive disconnect 10 is assembled, as is illustrated in FIG. 4, the engagement socket 203 of the female connector housing 202 that directly faces the opposite male part is inserted into the engagement socket 103 of the male connector housing 102. In a preferred embodiment, external dimensions and contour of the engagement socket 203 of the female connector housing 202 are sized and shaped correspondingly to the internal dimensions and contour of the socket 103 of the male connector housing 102. The matching of sizes and contours between the two sockets 103 and 203 allow for the smooth inserting assembly of the two housings 102 and 202, as well as their smooth retracting disassembly.

Such smooth sliding also allows for the proper alignment of the engagement end 122 of the male connector 120 with respect to the engagement end 222 of the female connector 220 as the two housings are pushed toward each other for the connection assembly of the disconnect 10. This leads to the smooth insertion of the engagement end 122 into the corresponding engagement end 222 when the disconnect 10 is fully assembled as shown in FIG. 4. In this case, two electrical circuits are established by the successful assembling of the disconnect 10 between the wire pairs 11M-11F and 12M-12F.

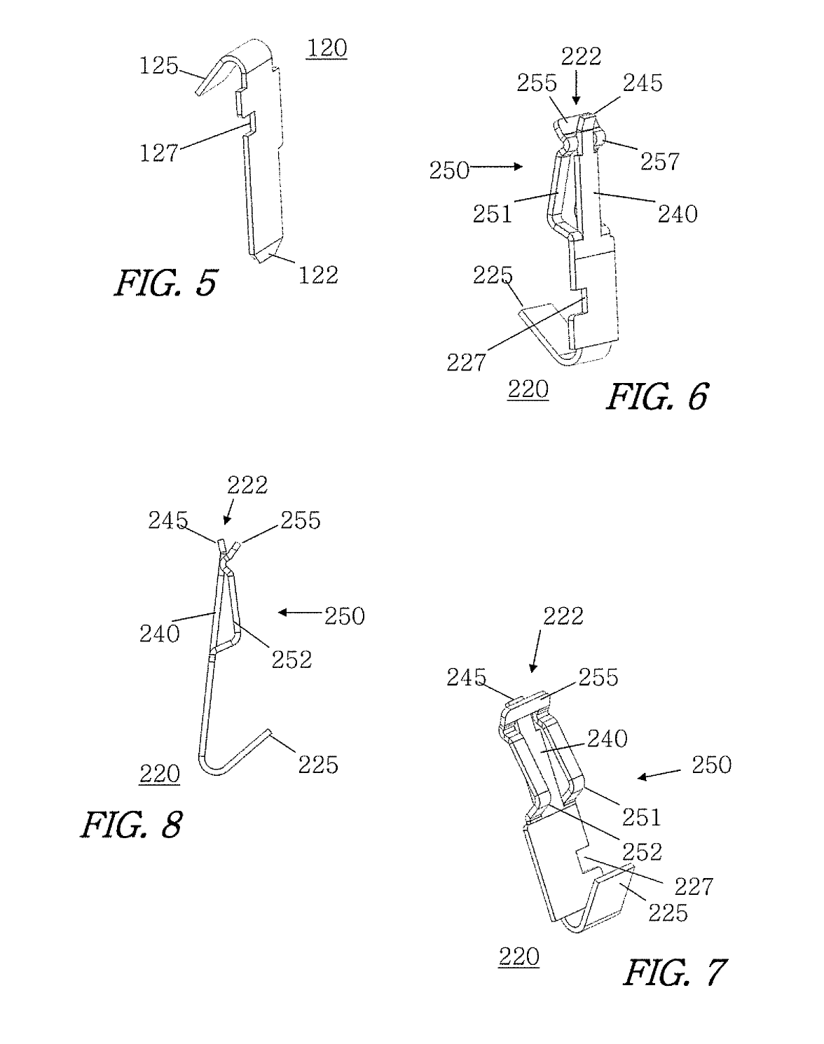

Each of the male and female connector engagement pairs that facilitates electrical connection for the disconnect 10 as described in FIGS. 3 and 4 is depicted in details in FIG. 5 and FIGS. 6-8 respectively. FIG. 5 is a perspective view of the male connector 120 for the disconnect 10 and FIG. 6 is a perspective view of the female connector 220 while FIG. 7 is another view, from a different perspective. FIG. 8 is the side view of the female connector 220 for the disconnect 10.

Note that in a preferred embodiment of the present invention, each of both the male 120 and female connector 220 can be made from single piece of metallic material. Preferably, they can be made by press-forming, a highly efficient yet low-cost mass production practice. Preferably, they can be made using phosphor copper, an alloy to provide best electrical connection with proper physical property to provide adequate mechanical strength for the necessary contact pressure between the male and female connectors.

As is illustrated in FIG. 5, opposite to the end where the wire engagement blade 125 is, the male connector 120 has an engagement end 122 for mating with the corresponding engagement end of the female connector. Correspondingly, as is shown in FIGS. 6, 7 and 8, the female connector 220 has at its one end an engagement end 222. This female engagement end 222 is generally formed to the shape of an opening to receive the protruding engagement end 122 of the mating male connector 120. The engagement end 222 of the female connector 220 forms, essentially, a gripping mechanism using its two fingers 240 and 250 so as the grip the engagement end 122 of the male connector 120 as it is inserted.

Note that in the exemplified embodiment of the present invention the finger 250 has two finger branches 251 and 252 as is illustrated. Ina preferred embodiment of the present invention, the fingers 240 and 250 of the female connector 220 are formed from one single piece of metal via metal work processes such as hydraulic stamping, therefore the formation of the finger branches 251 and 252 for the finger 250.

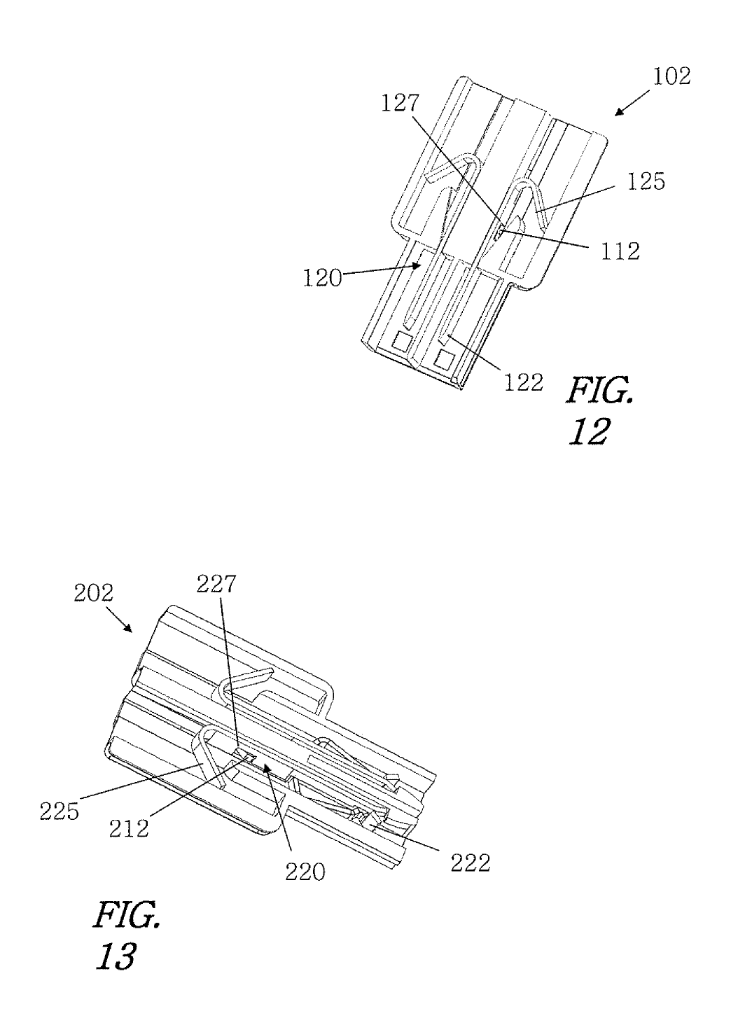

When assembling to establish electrical connection—such as between wire pairs exemplified in FIG. 1—the two housings, i.e., male connector housing 102 and female connector housing 202, are assembled together, as is illustrated in FIG. 2. The process starts with the insertion of the engagement socket 203 of the female connector housing 202 into the engagement socket 103 of the male connector housing 102. As is illustrated in the cross-sectional view of FIG. 3, the protruding end of the male connector engagement end 122 of the male connector 120 is aligned with the opening of the female connector engagement end 222 of the female connector 220. FIG. 9 is a detailed cross-sectional view of the disconnect of FIG. 3 with male and female connectors fully mated showing how the female connector exerts improved contact pressure to the male connector, as will be explained in further detail in FIGS. 10 and 11.

This alignment is easily and smoothly possible due to the guided insertion of the engagement socket 203 into the engagement socket 103. The proper alignment allows the male connector engagement end 122 to enter the opening at the female connector engagement end 222 as both housings 102 and 202 are pushed against each other. However, note that although the exemplifying disconnect 10 described herein has the engagement socket 203 of its female connector housing 202 inserted inside the engagement socket 103 of the male connector housing 102, an opposite arrangement is also feasible. For example, alternatively the engagement socket of the male connector housing 102 can be made so that it can be inserted inside the correspondingly-sized opening of the engagement socket of the female connector housing 202.

Note that during normal use such as by an electric technician in the new installation of a fluorescent lamp, the male and female connector housings 102 and 202 of a disconnect 10 would each already has its respective male 120 and female connector 220 installed in place inside. Normally the entire disconnect 10 is presented as an electrical connector system with two separable parts-seen by the user as a pair of connectors in the form of the housings 102 and 202. Wiring for the lamp can be inserted into the two separate male and female housings as suggested in FIG. 1. In the case an existing lamp is repaired, the disconnect 10 in question has its pair of male and female housings originally mated firmly for normal use must be physically separated for the technician to perform repair. In this case, both housings would have their respective wire pairs, live ones, connected.

For reliable electrical connection, the disconnect 10 needs to ensure firm electrical contact between the mating male 120 and female connector 220. One major factor for such a firm contact is a sufficient mechanical contact pressure at the point of contact between the male and female connectors. The key to the achievement of an enhanced mechanical contact pressure between the mated connectors is explained in FIGS. 10 and 11. Schematically FIGS. 10 and 11 respectively illustrate the side view of the pair of connectors before and after the reception of the insertion of the mating male connector inside the engagement socket section of the female connector housing.

As illustrated in FIG. 10, the female connector 220 may be loosely installed inside the engagement socket 203 of the female connector housing 202. This means the tip of both its contact finger 240 and pressure finger 250 may be free from simultaneous contact with the inner wall of the engagement socket 203 of the female connector housing 202.

Then, simultaneous reference to FIGS. 11 and 9 reveals how the disconnect 10 is able to provide a firm electrical connection with enhanced mechanical contact pressure. As the male and female connectors are mated, the engagement end 122 of the male connector 120 is aligned and inserted into the opening of the female connector 220 formed by its two fingers 240 and 250. The insertion forces the contact finger 240 and the pressure finger 250 of the female connector apart, literally away from each other to make space and allow for the presence of the engagement end 122 of the male connector 120. The internal space inside the engagement socket 203 is set to a width that is slightly smaller than the distance between the tip 245 of finger 240 and tip 255 of finger 250 when there is an insertion of the male connector engagement end 122. Note that the width between the tips of fingers of the female connector 220, with or without the insertion of the male connector 120, is the widest portion of the body of the female connector along its entire length-wise direction.

The fact that the width of the engagement socket 203 is smaller than the fingertip distance when there is an insertion constitutes no problem. In fact, this is essential for an enhanced mechanical pressure that the fingers 240 and 250 of the female connector 220 grip onto the inserted engagement end 122 of male connector 120. This is because the metallic nature of the fingers 240 and 250 of the female connector 220 allows for the deformation of themselves so that the fingertip distance is shortened to fit inside the engagement socket 203. It is because of this spring-loaded deformation of fingers 240 and 250 to provide the enhanced gripping mechanical force required for improved electrical contact characteristics.

Thus, with reference to the accompanying drawings, a disconnect 10 for electrically connecting wire pairs according to a preferred embodiment of the present invention would have a pair of male and female connector housings as well as a pair of male and female connectors. The male connector housing 102 has a male connector engagement socket 103 and the female connector housing 202 has a female connector engagement socket 203 for sleeve-engagement with the male connector engagement socket 103.

The male connector 120 is housed inside the male connector housing 102 and has a male connector engagement end 122. The female connector 220 is housed inside the female connector housing 202 and has a female connector engagement end 222. The female connector engagement end 222 has a contact finger 240 and a pressure finger 250 for mechanical gripping engagement with the male connector engagement end 122 when the male and female connector housings 102, 202 are sleeve-engaged and the male connector engagement end 122 is inserted between the contact and pressure fingers 240, 250.

In the preferred embodiment of the disconnect of the present invention, contact finger tip 245 of the contact finger 240 and the pressure finger tip 255 of the pressure finger 250 are forced apart from each other by the engagement insertion and are pressed onto inner sidewalls of the female connector engagement socket 203 for increasing the mechanical grip.

In other words, the internal space inside the female connector engagement socket 203 has a width that is larger than a distance between the contact finger tip 245 of the contact finger 240 and the pressure finger tip 255 of the pressure finger 250 when the male connector engagement end 122 is not inserted between the contact 240 and pressure finger 250.

In a preferred embodiment, the width between finger tips 245, 255 of the two fingers 240, 250 of the female connector 220 is the widest portion of its body along an entire length-wise direction with or without the insertion of the male connector 120.

It is necessary for the metallic male connector 120 to be securedly placed inside its protective housing 102 once it is installed inside. FIG. 12 is a cross-sectional view illustrating the structure to securely house and hold the male connector 120 inside its housing, the male connector housing 102. As the male connector 120 is installed inside the housing 102 by insertion toward the direction of the male connector engagement end 122, a latching recess 127 formed on the body of the connector 120 is latched by the corresponding connector latch 112 formed on the inner side wall of the housing 102, as is clearly seen in FIG. 12. Also refer to FIG. 5. This latching recess 127 is formed on the body of the metallic connector 120 generally between its wire engagement blade 125 and engagement end 122.

FIG. 13 is a cross-sectional view illustrating the structure to securely house and hold the female connector inside its housing. Similar as in the case of the male connector described above, as the female connector 220 is installed inside the housing 202 by insertion toward the direction of the female connector engagement end 222, a latching recess 227 formed on the body of the connector 220 is latched by the corresponding connector latch 212 formed on the inner side wall of the housing 202, as is clearly seen in FIG. 13. Also refer to FIGS. 6 and 7. This latching recess 227 is formed on the body of the metallic connector 220 generally between its wire engagement blade 225 and engagement end 222.

While the above is a full description of the specific embodiments, various modifications, alternative constructions and equivalents may be used. Therefore, the above description and illustrations should not be taken as limiting the scope of the present invention, which is defined by the appended claims.

1. A disconnect for electrically connecting wire pairs comprising:
a male connector housing having a male connector engagement socket;
a female connector housing having a female connector engagement socket for sleeve-engagement with said male connector engagement socket;
a male connector housed inside said male connector housing and having a male connector engagement end; and
a female connector housed inside said female connector housing and having a female connector engagement end, said female connector engagement end having a contact finger and a pressure finger for mechanical gripping engagement with said male connector engagement end when said male and female connector housings are sleeve-engaged and said male connector engagement end is inserted between said contact and pressure fingers;
wherein a contact finger tip of said contact finger and a pressure finger tip of said pressure finger are forced apart from each other by said insertion and are pressed onto inner sidewalls of said female connector engagement socket for increasing said mechanical grip.

2. The disconnect of claim 1 wherein an internal space inside said female connector engagement socket of said female connector housing has a width that is larger than a distance between said contact finger tip of said contact finger and said pressure finger tip of said pressure finger when said male connector engagement end is not inserted between said contact and pressure fingers.

3. The disconnect of claim 2 wherein said width between said tips of said fingers of said female connector is the widest portion of the body of said female connector along an entire length-wise direction thereof with or without said insertion of said male connector.

4. The disconnect of claim 1 wherein said male connector is made using one single-piece of metallic material by press-forming.

5. The disconnect of claim 1 wherein said female connector is made using one single-piece of metallic material by press-forming.

6. The disconnect of claim 1 wherein said male connector is made using phosphor copper.

7. The disconnect of claim 1 wherein said female connector is made using phosphor copper.
